(19) United States
(12) Patent Application Publication
(10) Pub. No.: US 2016/0140651 A1
(43) Pub. Date: May 19, 2016

(54) SYSTEM AND METHOD FOR INTEGRATED MODEL RISK MANAGEMENT

(71) Applicant: Genpact Luxembourg S.a.r.l., Luxembourg (LU)

(72) Inventors: Srinivas Prasad Va, Bangalore (IN); Rahul Goyal, Bangalore (IN); Animesh Mandal, Bangalore (IN); Manish Chopra, New Delhi (IN); Amit Bhaskar, Bangalore (IN)

(21) Appl. No.: 14/540,645

(22) Filed: Nov. 13, 2014

(51) Int. Cl. G06Q 40/00; G06Q 10/06

(52) U.S. Cl. CPC G06Q 40/00; G06Q 10/067

(57) ABSTRACT

A method and apparatus for validating models is provided where pre-validation of at least one model specific for at least one risk type is performed followed by validation of the model. The validation includes both quantitative and qualitative validation using various tests, approaches, and other criterion. The results of the validation operations are compiled and reported in a validation report.

### FIELD OF THE DISCLOSURE

The present description generally relates to assessing models across different disciplines and is more specifically directed to systems and methods for managing and validating models created for different purposes in financial institutions.

### BACKGROUND OF RELATED ART

Growing businesses and expanding markets have created the requirement for greater and more robust financial and statistical models for various functions and processes in financial institutions.

As used herein, the term “financial institution” generally refers to an institution that acts to provide financial services for its clients or members. Financial institutions include, but are not limited to, banks, building societies, credit unions, stock brokerages, asset management firms, savings and loans banks, money lending companies, insurance brokerages, insurance underwriters, and dealers in securities, credit card companies, and similar businesses.

These institutions are finding it very difficult to manage and validate the vast number of decision models spread across various teams, for example, Risk, Fraud, Collections, Marketing, etc. Usually, these institutions face stretched resources, and lack adequately skilled resources related to gauging model performance, model testing, and model risk management. This leads to increased turnaround time, manual errors, and inconsistencies in validation and related functionalities. Furthermore, new sets of regulatory guidelines from regulators like Basel, OCC, PRA, etc. are issued frequently, leading to high model rejection rate due to noncompliance.

Another key challenge in this area is that model risk management teams are not efficiently connected with the teams involved in model design and use, which leads to a dissonance between the model risk management and model design process.

Similarly, lack of strict and proper model risk management policies has also led to gaps in model risk management processes. Although new sets of regulatory guidelines from regulators like Basel, OCC (USA), and PRA (UK) are issued from time to time, it takes a lot of effort to comply with the necessary requirements. This translates to high model rejection rate for financial institutions.

The regulatory issues related to model risk management are compounded by a lack of appropriate management framework or operating model. The tools available in the market lack a number of critical functionalities that are required for efficient and all-around model risk management, and don't comply with minimum regulatory requirements. For example, there are tools available for quantitatively validating models associated with credit risk function risk types; however, the utility of such tools is limited. Financial institutions using such tools have to look for other options available in the market for validating models associated with other types of risk types, like the market risks and operational risks. Also, the models validated by such tools often face rejection from the regulatory/government bodies. This is because the tools for validating the models do not qualitatively validate the models.

Available tools also fail to enforce governance and incentives around model risk management. These tools also lack all-around functionalities such as model risk management oversight, task management, resource management, and activity management.

Furthermore, regulations around model risk management require financial institutions to disclose the status of model risk through a prescribed template. Available tools do not cater to this regulatory requirement.

In light of the above challenges faced by financial institutions and, by extension, their clients, there is a need for model risk management tools and processes that are not only efficient in addressing the above mentioned challenges, but also compliant with various existing regulatory guidelines set forth by regulatory bodies like Basel, OCC, PRA, etc.

The approaches described in this section are approaches that could be pursued, but not necessarily approaches that have been previously conceived or pursued. Therefore, unless otherwise indicated, it should not be assumed that any of the approaches described in this section qualify as prior art merely by virtue of their inclusion in this section.

### BRIEF DESCRIPTION OF THE DRAWINGS

FIG. 1 illustrates an example computer environment suitable for implementing the example integrated model risk management systems and methods disclosed.

FIG. 2 illustrates in block diagram form an example embodiment of the model risk management application of the present disclosure.

FIG. 3 illustrates in flowchart form an example process for validating a model in an embodiment of the present disclosure.

FIG. 4 illustrates an example process for quantitatively and qualitatively validating a model in an embodiment of the present disclosure.

FIG. 5 illustrates in block diagram form an example computing system upon which an embodiment of the present disclosure may be implemented.

### DETAILED DESCRIPTION

The following description of example methods and systems is not intended to limit the scope of the description to the precise form or forms detailed herein. Instead the following description is intended to be illustrative so that others may follow its teachings.

In the following description, for the purposes of explanation, numerous specific details are set forth in order to provide a thorough understanding of the present description. It will be apparent, however, that the present description may be practiced without these specific details. In other instances, well-known structures and devices are shown in block diagram form in order to avoid unnecessarily obscuring the present description.

Several features are described hereafter that can each be used independently of one another or with any combination of other features. However, an individual feature might only address one of the problems discussed above. Some of the problems discussed above might not be fully addressed by any of the features described herein. Although headings are provided, information related to a particular heading, but not found in the section having that heading, may also be found elsewhere in the specification.

### General Overview

Techniques for assessing model risks across various business divisions and different risk types are described. The following computer-implemented steps are performed in accordance with one embodiment of the present disclosure. A user selects at least one resource from a plurality of resources.

As used herein, “resource” relates to resources that are available to a user, which the user can assign for model risk management. These resources may include human resources, for example, other employees that may be assigned to validate one or models by using the model risk management application. The resources may also refer to computer resources, for example, memory blocks and processor cycles, which the user can distribute between the different models undergoing validation by the model risk management application.

Next, at least one risk type is selected from a set of risk types. As used herein, the term “risk type” relates to the type of risk in any field. For example, in finance, one risk type is the risk that the return achieved on an investment will be different from that expected. “Risk types” may be mathematical functions derived quantitatively, qualitatively, or both that denote said risks. Financial risks and, likewise, financial risk types can be further categorized, for example, as systematic risk, basis risk, credit risk, capital risk, sovereign risk, default risk, delivery risk, economic risk, management risk, exchange rate risk, interest rate risk, liquidity risk, market risk, operational risk, payment system risk, political risk, refinancing risk, reinvestment risk, counter-party risk, and underwriting risk. Risk types may also relate to risks in other industries, for example, education, transport, defense, and healthcare. In different institutions, each risk type is evaluated by one or more risk management groups. These risk management groups develop, own, manage, support, and use the multiple models to evaluate the one or more risk types.

Next, at least one model is selected. The selected model is associated with the assessment of a material risk within the selected risk type. Each risk type supports certain models that the user can choose from, or the user can specify their own customized model. As used herein, the term “model” relates to an abstract representation of a real world situation. In finance, this abstract representation may be a mathematical model designed to represent (a simplified version of) the performance of a financial asset or portfolio of a business, project, investment, or other financial instruments. A financial model may comprise one or more sets of equations. A model may also comprise a method, system or approach that applies statistical, economical, financial, and/or mathematical theories, techniques and assumptions to process input data into quantitative estimates. The model definition also covers quantitative approaches whose inputs are partially or wholly qualitative or based on expert judgment, provided that the output is quantitative in nature.

The selected model is pre-validated. Subsequently, the model is validated. The validation includes quantitative validation, which entails running one or more model level tests and one or more factor level tests on the model. The validation also includes qualitative validation, which is based in part on a user's responses to standardized questions. The results of the validation are documented in the validation report.

In other embodiments, the disclosure encompasses a non-transitory computer-readable medium configured to perform the foregoing method or steps.

In yet another embodiment, the disclosure encompasses an apparatus comprising different modules for performing the foregoing method or steps.

It should be appreciated that, although example embodiments of the disclosure are described herein as involving a financial institution, and the models validated by the model risk management application are also financial models, other embodiments of the disclosure may involve any type of institution and validation of their financial or non-financial models.

### System Overview of Example Embodiment

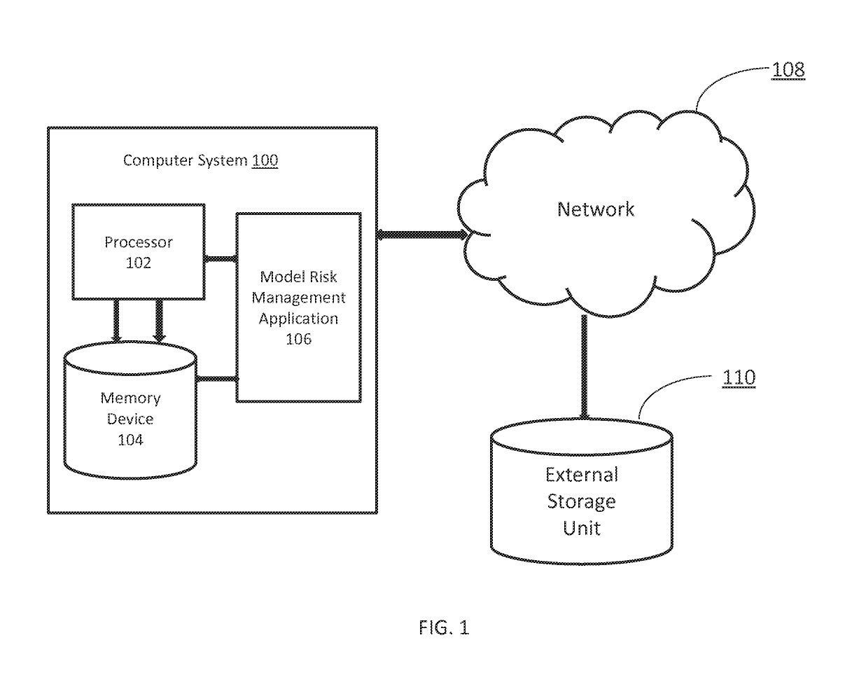

FIG. 1 illustrates an example computer-networking environment for implementation of at least one embodiment of the present disclosure. In one embodiment, the computer system 100 comprises a computing device configured as a management station, and such may be structured as the example computing device described herein in the “Hardware Overview” section. In another embodiment, the computer system 100 may be a specialized computing device. For example, the computer system 100 may be a video infrastructure or audio infrastructure device that is optimized for services such as video conferencing, digital telephony, and/or telepresence. In still other embodiments, the computer system 100 represents network end stations such as laptop computers, server computers, mobile computers, tablet computers, smartphones, etc., or may represent software components executing on one or more computing systems. In another embodiment, the computer system 100 may represent several different interconnected computers or computer systems operating as a cloud-based computing system.

In one embodiment, the computer system 100 is a computing device or software component providing a user interface, with a processor 102 and a memory device 104 which allows users to validate models using a model risk management application 106. In one embodiment, the model risk management application 106 may be implemented as an application with a graphical user interface executing on the computer system 100. In another embodiment, the model risk management application 106 may be implemented as an application with a graphical user interface executing across separate interconnected computer systems, as described herein.

The computer system 100 may be connected to an external storage unit 110 through a network 108. In one embodiment, the network 108 represents any combination of one or more local networks, wide area networks, and/or internetworks coupled using wired or wireless links deployed using terrestrial or satellite connections. Data exchanged over the network may be transferred using any number of network layer protocols, such as Internet Protocol (IP), Multiprotocol Label Switching (MPLS), Asynchronous Transfer Mode (ATM), Frame Relay, etc. Furthermore, in embodiments where the network represents a combination of multiple sub-networks, different network layer protocols may be used at each of the underlying sub-networks. In some embodiments, the network may represent one or more interconnected internetworks, such as the public Internet.

In an embodiment, the external storage unit 110 may be one or more storage devices attached to the central server of a client institution. In another embodiment, the external storage unit 110 may be an off-site storage or backup device. In still another embodiment, the external storage unit 110 may be the memory device of another computer system similar to the one described above or one described in the “Hardware Section” herein. In another embodiment, the external storage unit 110 may be one or more separate memory devices on the computer system 100 that are configured as a centralized model inventory which can store all the models that are undergoing model risk management by the model risk management application 106. In an embodiment, financial institutions may store model related documents of all models across all functions, for example, model development documents, past validation reports, spreadsheets, and implementation code, in the external storage unit 110.

Although only a particular number of elements are depicted in FIG. 1, a practical environment may have many more of each depicted element. For example, the computer system 100 may be communicatively coupled to the external storage unit 110 directly or indirectly through one or more networks. The computer system 100 may have one or more processors and one or more storage devices. Further, there may be more than one instance of the model risk management application 106 executing on the computer system 100 simultaneously.

### Overview of Model Risk Management Application

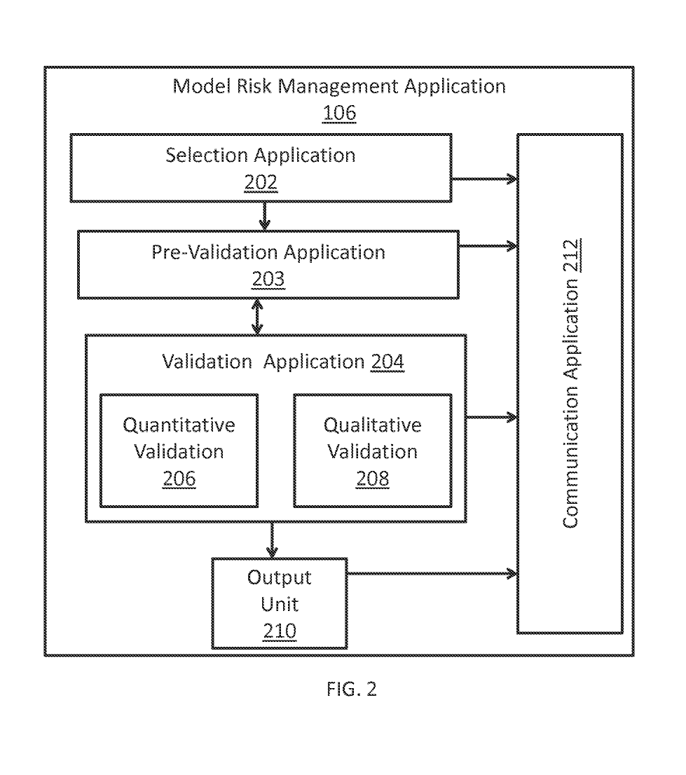

FIG. 2 illustrates a block diagram of an example embodiment of the model risk management application. FIG. 2 illustrates a more detailed example of the model risk management application 106. It will be appreciated that, although FIG. 2 illustrates a model risk management application 106 on a single computing device, other embodiments may implement the model risk management application 106 across a number of different computing devices.

In an embodiment, the model risk management application 106 includes a selection application 202. In an embodiment, the selection application 202 comprises an application with a graphical user interface implemented on the computer system 100 to enable a user to select appropriate resources to be assigned for the model risk management process. In another embodiment, the selection application 202 enables a user to reassign resources from one model risk management process to another. In yet another embodiment, the selection application 202 enables a user to un-assign resources for a model risk management process. In another embodiment, the selection application 202 enables the assigned resource to select the appropriate risk type and choose the one or more associated models before the model risk management process. In one embodiment, the selection application 202 may be a standalone application executing on a computer system separate from the computer system 100 executing the model risk management application 106. In an embodiment, the selection application 202 may consist of a separate storage device to store data, for example, different built-in models associated with the various risk types. In another embodiment, the selection application 202 stores the data, for example, different built-in models associated with the various risk types, in the memory device 104 associated with the computer system 100.

The selection application 202 may be communicatively coupled to a pre-validation application 203. In one embodiment, the pre-validation application consists of an application with a graphical user interface implemented on the computer system 100 to enable a user to authenticate the model selected by the selection application 202 prior to model validation. In an embodiment, the pre-validation application 203 may be a standalone application executing on a computer system separate from the computer system 100 executing the model risk management application 106.

The pre-validation application 203 may be communicatively coupled to a validation application 204 which further comprises two independent sub-applications, a quantitative validation application 206, and a qualitative validation application 208. In an embodiment, the validation application 204 consists of an application with a graphical user interface implemented on the computer system 100 to enable a user to validate the model authenticated by the pre-validation application 203. In an embodiment, the validation application 204 may be a standalone application executing on a computer system separate from the computer system 100 executing the model risk management application 106.

The validation application 204 may be communicatively coupled to an output application 210. In an embodiment, the output application 210 includes hardware, software, or a combination of both to display the output of the validation application 204. For example, the output application 210 may consist of a graphical user interface implemented on a computer system to display the results of the model risk management on a screen. In another example, the output application 210 may also include printers and other hardware devices to generate output of the model risk management operation in various formats.

In an embodiment, the model risk management application 106 also includes a communication application 212. In one embodiment, the communication application 212 is implemented as hardware, software, or a combination of both to enable communication between the model risk management application 106 and the users, and between the users themselves. In an embodiment, the communication application 212 is configured as an email client for automatically generating e-mails to provide status updates about the various models at different stages of the model risk management process to the users. In another embodiment, the communication application 212 is configured as an Internet messaging program. In yet another embodiment, the communication application 212 consists of telephonic or fax equipment.

### Process for Model Risk Management

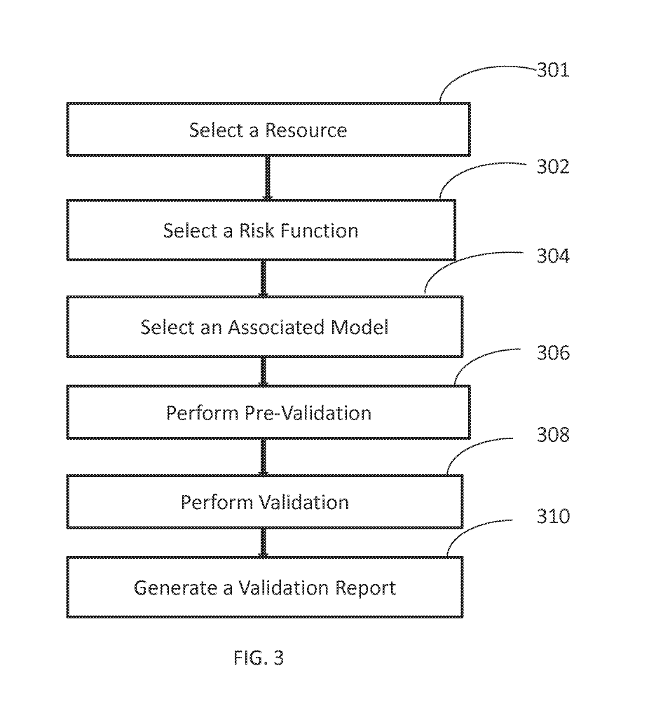

FIG. 3 illustrates an example process for model risk management of a particular model by the model risk management application 106, according to the preferred embodiment. For purposes of illustrating clear examples, the process flow depicted in FIG. 3 will be discussed in connection with the model risk management application 106 of FIG. 2. However, a same or substantially similar process can be used for other implementations.

Referring now to FIG. 3, at block 301 the process enables a user to assign at least one resource for the model risk management process using the selection application 202.

At block 302 the process enables a user to select a risk type using the selection application 202. In one embodiment, the risk types are selected from credit risk, operation risk, and management risk types. In another embodiment, the risk types are selected from other risk types described herein or in the prior art.

At block 304, the process enables a user to choose a model associated with the risk type selected in block 302 for validation using the selection application 202. In an embodiment, the associated model is selected from a set of built-in models. For example, for credit risk type, the user may have several models to choose from such as Probability of Default (PD) model, Exposure at Default (EAD) model, Loss Given Default (LGD) model, Pricing models, Credit application scorecards/models, Borrower rating model, Facility rating model, Behavior scorecard, Limit management scorecards, Stress testing models (Comprehensive Capital Analysis and Review (CCAR)/Dodd-Frank Act Stress Tests (DFAST)), Provisioning models (Allowance for Loan and Lease Losses (ALLL)), Loss forecasting models, Collections scorecards, Balance sheet forecasting model, Single-name concentration model, and Sectoral concentration model. In an embodiment, the user selects a customizable model associated with the risk type selected at block 302 and inputs the independent variables, dependent variable, sources for the dependent variable and independent variables, and documentation associated with the customizable model. For example, the user selects a new model for loan defaults as determined by using the equation:

y=dx+c

Where y is the independent variable representing risk of default for a particular class of loans, x is the dependent variable denoting a particular demographic indicator, and d and c are constants. In this scenario, the user has to input x and y, data sources for x and y, and documentation.

The process then moves to block 306. Here the process authenticates the model selected at block 304 using the pre-validation application 203 to determine if the model selected is ready for validation. In an embodiment, the pre-validation consist of providing a checklist to the user so that the user may determine whether all the requisite pre-validation criteria have been met. For example, if the user selects a customizable model, the checklist can help the user identify whether the user has uploaded all the essentials before the model can be validated. In another embodiment, the pre-validation application 203 automatically performs the pre-validation to verify the models. For example, the pre-validation application may automatically run data integrity checks and format checks on the selected model or the custom data sources.

At block 308, the process validates the authenticated model from block 306. In an embodiment, the validation includes qualitative validation, quantitative validation, or both.

The process then moves to block 310. Here, the process generates a validation report using the output application 210 after the completion of validation. In an embodiment, the validation report contains status indicators that indicate the status of the results of the validation on the model. For example, the status indicators may be in the form of a color scheme like Red-Amber-Green (RAG) for each of qualitative and quantitative validation operation run on the model. For quantitative validation, the Red-Amber-Green status indicators may indicate major gaps between Development and Validation numbers. For example, if the gap is within 5% then the results may be colored in Green suggesting ‘little or no change’. If the gap is with 5%-10%, then the results may be colored in Amber suggesting ‘some change.’ If the gap is more than 10%, then the results may be colored in Red suggesting ‘major change.’ Similarly, for qualitative validation, the user can define the Red-Amber-Green for each section to highlight model strengths and weaknesses for every section. In another embodiment, the validation report may consist of one or more graphs, histograms, pie charts or other statistical representations indicating the results of the validation. In an embodiment, the validation reports may be submitted to the financial institution's senior management to review model fitness. In an embodiment, based on the validation report, the senior management may decide whether to continue using the selected model or to re-develop the selected model. In an embodiment, the model risk management can be carried out throughout the lifecycle of the model.

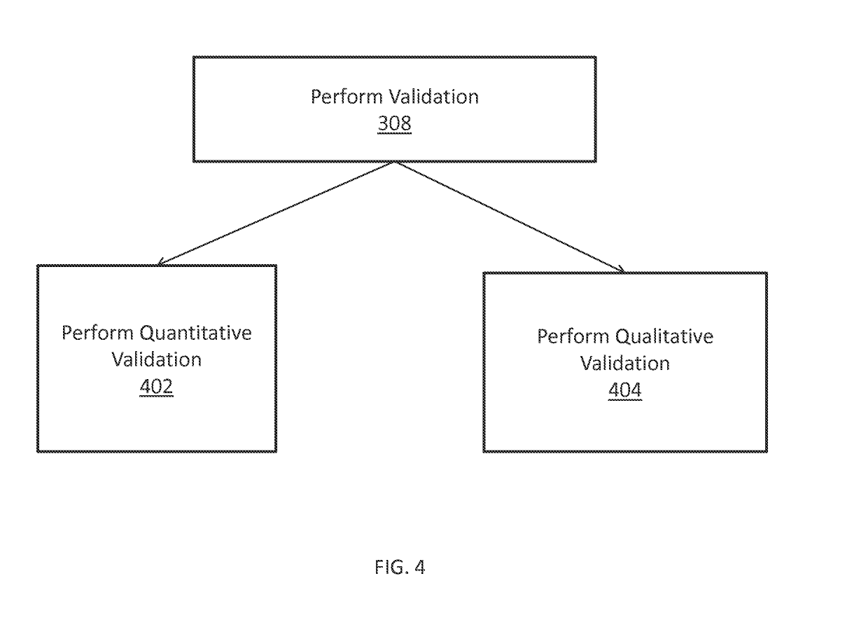

FIG. 4 illustrates a process for quantitatively and qualitatively validating a model in an embodiment. For purposes of illustrating clear examples, the process flow depicted in FIG. 4 will be discussed in connection with the model risk management application 106 of FIG. 2. However, a same or substantially similar process can be used for other implementations. Referring now to FIG. 4, at block 402 the process quantitatively validates a model by using the qualitative validation application 206 on the authenticated model. In an embodiment, the quantitative validation includes testing the authenticated model by running one or more model-level tests from a plurality of model-level tests, or one or more factor-level tests from a plurality of factor level tests, or both depending upon the type of model.

Here, the “type” of model refers to the mathematical nature of the model. For example, the model may be a binary outcome model like possibility of default model/behavior scorecard, credit application scorecard, limit management scorecards, borrowing rate models, facility rating model, retail pooling model, single name concentration models, collection decision scorecards; continuous outcome models like loss given default model, exposure at default model, risk based credit pricing model, and concentration risk model; or time series models such as stress testing models, provisioning models, loss forecasting models, balance sheet forecasting models.

In an embodiment, the model-level tests and factor-level tests consist of inbuilt statistical tests that compare model performance between development and out of time data. For example, the model-level tests may include Gini coefficient, CIER, Hosmer Lemeshow Test, BRIER Score, Mean Absolute Percentage Error (MAPE), Rank Ordering, Ranking Decile, KS Statistics, KS Decile, Concordance, Discordance, Ties, Divergence Index, Max Cluster Size of Predicted Score, Population Stability Index, Information Value, Adjusted R-Square, Loss Percentage Capture Ratio, Expected Loss Shortfall, Confusion Matrix by Count, Confusion Matrix by Exposure, Confusion Matrix by Loss, Ranking Decline, Population Stability Index, Augumented Dicker-Fuller Test (ADF), Auto Correlation Function (ACF), Partial ACF, Durbin Watson Test, Pearson's Linear Correlation Test, Goodness of Fit Test, and/or Jarque-Bera Test. Examples of the factor-level tests include Characteristic Analysis, Information Value, and Variance Inflation Factor, among others.

At block 404, the process runs qualitative validation on the authenticated model using the qualitative validation application 208 simultaneous to the running of the quantitative validation in block 402. In an embodiment, the qualitative validation consists of collecting responses to a set of built-in standardized questions presented to the user. The built-in standardized questions may enable a user to covers aspects such as model design, assumptions, weaknesses, and business usability during the validation process. In one embodiment, the user must answer all of the questions. In another embodiment, the user may skip over some or all of the questions. In one embodiment, the user can answer the questions by selecting the appropriate answers from a set of options. In another embodiment, the user has to answer the questions subjectively by filling in comment boxes. In one embodiment, the list of questions is extensible. In another embodiment, the standardized questions are split into different sections. In yet another embodiment, the qualitative validation consists of collecting a response to at least one built-in standardized question.

An example of the above process is a user, user A, selecting a resource, for example, user B, for model risk management. The selected resource then selects the credit risk type. The selected resource, after selecting the credit risk type in the previous step, selects one of the models, such as the PD model, which is associated with the credit risk type. PD is a financial term describing the likelihood of a default over a particular time horizon. It provides an estimate of the likelihood that a borrower will be unable to meet its debt obligation. Typically, the PD model is derived by analyzing the obligor's capacity to repay the debt in accordance with contractual terms. PD is generally associated with financial characteristics such as inadequate cash flow to service debt, declining revenues or operating margins, high leverage, declining or marginal liquidity, and the inability to successfully implement a business plan. In addition to these quantifiable factors, the borrower's willingness to repay must also be evaluated. However, the user may also select a customized model of PD for validation based on specific criteria like credit scores. After selection of the PD model, the PD model is authenticated prior to validation. For example, pre-validation may involve data integrity checks for missing values and outliers, missing target variables, as well as minimum requirements check like appropriate data with all the necessary fields, documents, and result spreadsheets. The PD model is then validated quantitatively, qualitatively, or both. The PD model can be validated quantitatively by subjecting it to one or more model-level tests, such as Gini Coefficients, Rank Ordering, and/or KS Statistics and factor-level tests such as Characteristic Analysis and Informative Value. The PD model may also be validated qualitatively by collecting user responses to questions such as:

| 2.2 | Credit approval |
|---|---|
| 2.2.2 | Are model outputs used and/or referenced in the credit under- |
| | writing process? |
| 2.2.3 | Are model outputs used in setting credit authority levels? |

After validation of the PD model, a report is generated. This report indicates the results of the various model-level and factor-level tests for quantitative validation, and the results of qualitative validation through the RAG status indicators. The validation report may include graphs, pie charts and other statistical representations to track model performance across time to ensure that the model predicts stable and reliable results over time.

### Hardware Overview

According to one embodiment of the present disclosure, the techniques described herein are implemented by one or more special-purpose computing devices. The special-purpose computing devices may be hard-wired to perform the techniques, or may include digital electronic devices such as one or more application-specific integrated circuits (ASICs) or field programmable gate arrays (FPGAs) that are persistently programmed to perform the techniques, or may include one or more general purpose hardware processors programmed to perform the techniques pursuant to program instructions in firmware, memory, other storage, or a combination. Such special-purpose computing devices may also combine custom hard-wired logic, ASICs, or FPGAs with custom programming to accomplish the techniques. The special-purpose computing devices may be desktop computer systems, portable computer systems, handheld devices, networking devices or any other device that incorporates hard-wired and/or program logic to implement the techniques.

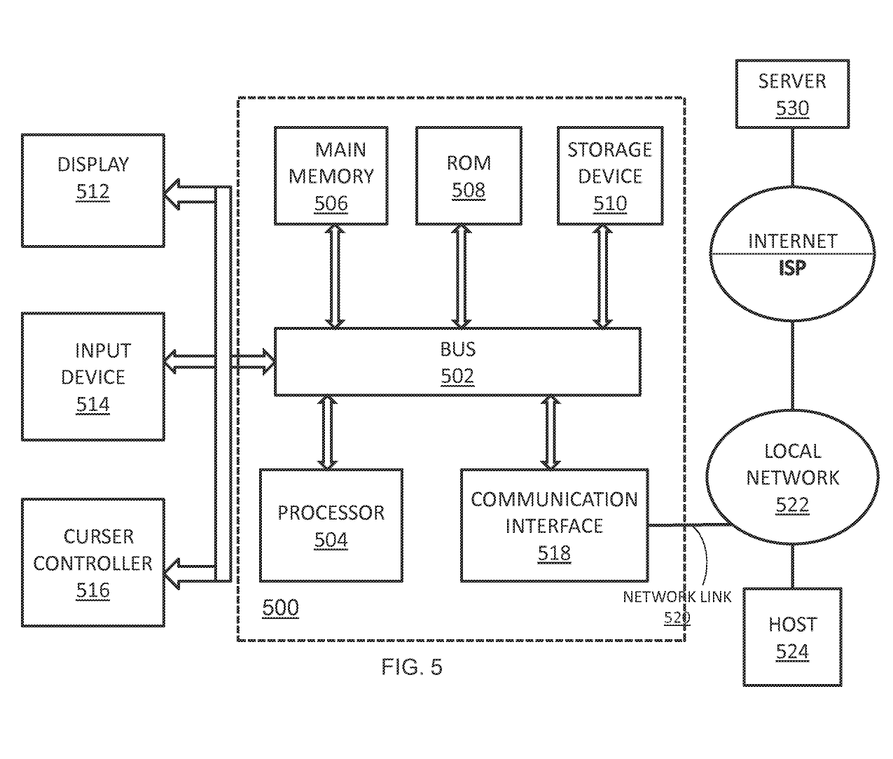

For example, FIG. 5 is a block diagram that illustrates a computer system 500 upon which an embodiment of the present disclosure may be implemented. The computer system 500 may include a bus 502 or other communication mechanism for communicating information, and a processor 504 coupled with the bus 502 for processing information. The hardware processor 504 may be, for example, a general purpose microprocessor.

The computer system 500 may also include a main memory 506, such as a random access memory (RAM) or other dynamic storage device, coupled to the bus 502 for storing information and instructions to be executed by the processor 504. The main memory 506 also may be used for storing temporary variables or other intermediate information during execution of instructions to be executed by the processor 504. Such instructions, when stored in non-transitory storage media accessible to the processor 504, render the computer system 500 into a special-purpose machine that is customized to perform the operations specified in the instructions.

The computer system 500 further includes a read only memory (ROM) 508 or other static storage device coupled to the bus 502 for storing static information and instructions for the processor 504. A storage device 510, such as a magnetic disk, optical disk, or solid-state drive is provided and coupled to the bus 502 for storing information and instructions.

The computer system 500 may be coupled via the bus 502 to a display 512, such as a cathode ray tube (CRT), for displaying information to a computer user. An input device 514, including alphanumeric and other keys, is coupled to the bus 502 for communicating information and command selections to the processor 504. A cursor control 516, such as a mouse, a trackball, or cursor direction keys, may also be coupled to the bus 502 for communicating direction information and command selections to the processor 504 and for controlling cursor movement on the display 512. The cursor control 516 typically has two degrees of freedom in two axes, a first axis (e.g., x) and a second axis (e.g., y), that allows the cursor control 516 to specify positions in a plane.

The computer system 500 may implement the techniques described herein using customized hard-wired logic, one or more ASICs or FPGAs, firmware and/or program logic which causes the computer system 500 to be a special-purpose machine. According to one embodiment, the techniques herein are performed by the computer system 500 in response to the processor 504 executing one or more sequences of one or more instructions contained in the main memory 506. Such instructions may be read into the main memory 506 from another storage medium, such as the storage device 510. Execution of the sequences of instructions contained in the main memory 506 cause the processor 504 to perform the process steps described herein. In alternative embodiments, hard-wired circuitry may be used in place of or in combination with software instructions.

The term “storage media” as used herein refers to any non-transitory media that store data and/or instructions that cause a machine to operate in a specific fashion. Such storage media may comprise non-volatile media and/or volatile media. Non-volatile media includes, for example, optical disks, magnetic disks, or solid-state drives, such as the storage device 510. Volatile media may include dynamic memory, such as the main memory 506. Common forms of storage media include, for example, a floppy disk, a flexible disk, hard disk, solid-state drive, magnetic tape, or any other magnetic data storage medium, a CD-ROM, any other optical data storage medium, any physical medium with patterns of holes, a RAM, a PROM, and EPROM, a FLASH-EPROM, NVRAM, or any other memory chip or cartridge.

Storage media is distinct from, but may be used in conjunction with, transmission media. Transmission media participates in transferring information between storage media. For example, transmission media may include coaxial cables, copper wire and fiber optics, including the wires that comprise the bus 502. Transmission media can also take the form of acoustic or light waves, such as those generated during radio-wave and infra-red data communications.

Various forms of media may be involved in carrying one or more sequences of one or more instructions to the processor 504 for execution. For example, the instructions may initially be carried on a magnetic disk or solid-state drive of a remote computer. The remote computer can load the instructions into its dynamic memory and send the instructions over a telephone line using a modem. A modem local to the computer system 500 can receive the data on the telephone line and use an infra-red transmitter to convert the data to an infra-red signal. An infra-red detector can receive the data carried in the infra-red signal and appropriate circuitry can place the data on the bus 502. The bus 502 carries the data to the main memory 506, from which the processor 504 retrieves and executes the instructions. The instructions received by the main memory 506 may optionally be stored on the storage device 510 either before or after execution by the processor 504.

The computer system 500 also includes a communication interface 518 coupled to the bus 502. The communication interface 518 provides a two-way data communication coupling to a network link 520 that is connected to a local network 522. For example, the communication interface 518 may be an integrated services digital network (ISDN) card, cable modem, satellite modem, or a modem to provide a data communication connection to a corresponding type of telephone line. As another example, the communication interface 518 may be a local area network (LAN) card to provide a data communication connection to a compatible LAN. Wireless links may also be implemented. In any such implementation, the communication interface 518 sends and receives electrical, electromagnetic or optical signals that carry digital data streams representing various types of information.

The network link 520 typically provides data communication through one or more networks to other data devices. For example, the network link 520 may provide a connection through the local network 522 to a host computer 524 or to data equipment operated by an Internet Service Provider (ISP) 526. The ISP 526 in turn provides data communication services through the world wide packet data communication network now commonly referred to as the “Internet” 528. The local network 522 and the Internet 528 both use electrical, electromagnetic or optical signals that carry digital data streams. The signals through the various networks and the signals on the network link 520 and through the communication interface 518, which carry the digital data to and from the computer system 500, are example forms of transmission media.

The computer system 500 can send messages and receive data, including program code, through the network(s), the network link 520 and the communication interface 518. In the Internet example, a server 530 might transmit a requested code for an application program through the Internet 528, the ISP 526, the local network 522 and the communication interface 518. The received code may be executed by the processor 504 as it is received, and/or stored in the storage device 510, or other non-volatile storage for later execution.

Although certain example methods and apparatus have been described herein, the scope of coverage of this patent is not limited thereto. On the contrary, this patent covers all methods, apparatus, and articles of manufacture fairly falling within the scope of the appended claims either literally or under the doctrine of equivalents.

We claim:

1. A computer-implemented method comprising:
selecting at least one resource from a plurality of resources for model risk management, wherein said model risk management comprises:
selecting at least one risk type from a set of risk types;
selecting at least one model, wherein the at least one model is associated with the at least one risk type;
pre-validating the at least one model;
validating the at least one model; and
generating a validation report, wherein the validating the at least one model comprises at least one of:
quantitative validation of the at least one model; and
qualitative validation of the at least one model, wherein the qualitative validation is based, at least in part, on a user's responses to a set of standardized questions, and wherein the quantitative validation comprises at least one of:
testing the at least one model using at least one model-level test from a plurality of built-in model-level tests; and
testing the at least one model using at least one factor-level test from a plurality of built-in factor-level tests.

2. A computer-implemented method of claim 1, wherein the at least one model comprises at least one of:
a built-in model from a set of built-in models; and
a customized model, wherein the customized model comprises a dependent variable, a set of independent variables, a set of data sources for said dependent variable and said set of independent variables, and a set of documentation.

3. A computer-implemented method of claim 1, wherein the pre-validating the at least one model comprises presenting an automatically-generated checklist to a user.

4. A computer-implemented method of claim 1, wherein each standardized question in the set of standardized questions belongs to a section in a plurality of sections.

5. A computer-implemented method of claim 4, wherein the validation report comprises a set of status indicators depicting a current status of at least one of:
a result of a set of results generated by said quantitative validation; and
each section of the plurality of sections.

6. A computer-implemented method of claim 5, wherein the validation report contains a set of graphical representations depicting the set of results.

7. A computer-implemented method of claim 1, further comprising maintaining a central repository, wherein the central repository stores at least one of:
each of the at least one model undergoing validation by the validation module; and
each of the at least one model that has been validated by the validation module.

8. A computer-implemented method of claim 1, further comprising automatically generating an e-mail, wherein said e-mail includes the validation report generated for the at least one model.

9. A non-transitory computer-readable storage medium storing one or more sequences of instructions, the instructions, when executed by one or more processors, cause the one or more processors to perform steps comprising:
selecting at least one resource from a plurality of resources for model risk management, wherein said model risk management comprises:
selecting at least one risk type from a set of risk types;
selecting at least one model, wherein the at least one model is associated with the at least one risk type;
pre-validating the at least one model;
validating the at least one model; and
generating a validation report, wherein said validating the at least one model comprises at least one of:
quantitative validation of the at least one model; and
qualitative validation of the at least one model, wherein the qualitative validation is based, at least in part, on a user's responses to a set of standardized questions, and wherein said quantitative validation comprises at least one of:
testing the at least one model using at least one model-level test from a plurality of built-in model-level tests; and
testing the at least one model using at least one factor-level test from a plurality of built-in factor-level tests.

10. A non-transitory computer-readable storage medium of claim 9, wherein the at least one model comprises at least one of:
a built-in model from a set of built-in models; and
a customized model, wherein said customized model comprises a dependent variable, a set of independent variables, a set of data sources for said dependent variable and said set of independent variables, and a set of documentation.

11. A non-transitory computer-readable storage medium of claim 10, wherein the pre-validating the at least one model comprises presenting an automatically-generated checklist to a user.

12. A non-transitory computer-readable storage medium of claim 10, wherein each standardized question in the set of standardized questions belongs to a section in a plurality of sections.

13. A non-transitory computer-readable storage medium of claim 12, wherein the validation report comprises a set of status indicators depicting a current status of at least one of:
a result of the set of results generated by the running of each of the at least one model-level test and each of the at least one factor-level test; and
each section of the plurality of sections.

14. A non-transitory computer-readable storage medium of claim 13, wherein the validation report contains a set of graphical representations depicting the set of results.

15. An apparatus comprising:
a memory device;
a processor communicatively coupled to the memory device;
at least one workflow module configured to assign at least one resource from a plurality of resources for risk management to at least one model;
at least one logic module configured to:
select at least one risk type from a set of risk types; and
select the at least one model, wherein the at least one model is associated with the at least one risk type;
at least one pre-validation module configured to pre-validate the at least one model;
at least one validation module configured to validate the at least one model; and
at least one output module configured to generate a validation report, wherein validating the at least one model comprises at least one of:
quantitative validation of the at least one model; and
qualitative validation of the at least one model, wherein said qualitative validation is based, at least in part, on a user's responses to a set of standardized questions, and wherein said quantitative validation comprises at least one of:
testing the at least one model using at least one model-level test from a plurality of built-in model-level tests; and
testing the at least one model using at least one factor-level test from a plurality of built-in factor-level tests.

16. An apparatus of claim 15, wherein the at least one model comprises at least one of:
a built-in model from a set of built-in models; and
a customized model, wherein said customized model comprises a dependent variable, a set of independent variables, a set of data sources for said dependent variable and said set of independent variables, and a set of documentation.

17. An apparatus of claim 15, wherein the pre-validating the at least one model comprises presenting an automatically-generated checklist to a user.

18. An apparatus of claim 15, wherein each standardized question in the set of standardized questions belongs to a section in a plurality of sections.

19. An apparatus of claim 18, wherein the validation report comprises a set of status indicators depicting a current status of at least one of:
a result of the set of results generated by the running of each of the at least one model-level test and each of the at least one factor-level test; and
each section of the plurality of sections.

20. An apparatus of claim 19, wherein the validation report contains a set of graphical representations depicting the set of results.

21. An apparatus of claim 15, further comprising at least one datastore module for maintaining a central repository, wherein the central repository stores at least one of:
each of the at least one model undergoing validation by the validation module; and
each the at least one model that has been validated by the validation module.

22. An apparatus of claim 15, further comprising a communication module, wherein the communication module automatically generates an e-mail, wherein said e-mail includes the validation report generated for the model.
